(19) United States
(12) Patent Application Publication
(10) Pub. No.: US 2005/0008956 A1
(43) Pub. Date: Jan. 13, 2005

(54) Color image forming method and combination of using developers

(75) Inventors: Shuitsu Sato, Tokyo (JP); Takahito Kabai, Shizuoka-ken (JP); Takashi Urabe, Shizuoka-ken (JP); Yasuhito Noda, Shizuoka-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/884,925

(22) Filed: Jul. 7, 2004

(30) Foreign Application Priority Data
Jul. 11, 2003 (JP) 2003-196013

(51) Int. Cl. G03G 15/01

(52) U.S. Cl. 430/45; 430/107.1; 430/47

(57) ABSTRACT

In a color image forming method comprising the steps of forming a primary transferring image comprising plural developer images in different colors on an intermediate transferring belt by repeating the process to develop and transfer developer images on an intermediate transferring belt and forming a secondary transferring image by transferring the primary transferring image on a transfer paper, absolute values of tribo-charge amount of plural kinds of developers are 10 to 30 μC/g, and an absolute value of tribo-charge amount of a developer used lastly for the development is larger than that of a developer first used for the development and a difference between them is more than 2 μC/g×(number of developers used −1).

### CROSS-REFERENCE TO RELATED APPLICATION

This application is based upon and claims the benefit of priority from the prior Japanese Patent Application No. 2003-196013 filed on Jul. 11, 2003; the entire contents of which are incorporated herein by reference.

### BACKGROUND OF THE INVENTION

1. Field of the Invention

The present invention relates to a color image forming method and developers for developing static charge images and magnetic latent images in an electro-photographic method, an electrostatic printing method, a magnetic recording method, etc. and more particularly to a color image forming method using one image carrier, plural developing units and an intermediate transferring member for primary transferring developer images and developers used therefor.

2. Description of the Related Art

For an image forming method and an image forming apparatus using the electro-photographic technology, an intermediate transferring means that runs endlessly in order to transfer plural visible color developer images that are formed sequentially on an image carrier, for example, a photosensitive drum is used. As this intermediate transfer means, for example, an intermediate transfer belt is used. Plural visible color developer images formed on a photosensitive body are superposed in order on this intermediate transfer belt for the primary transferring. An image forming method and an apparatus of this intermediate transferring system to transfer the primary images transferred on this intermediate transfer belt in a lump are known.

Such an intermediate transfer system is adopted as a color toners superposing/transferring system in a so-called full-color image forming apparatus to reproduce color separated document images using a subtractive process of black, cyan, magenta and yellow toners.

As another method to form a full-color image by superposing images in different colors on a transferring material, there is a method to once superpose color toner images formed sequentially on a photosensitive drum and finally transfer the toner images formed on an intermediate transfer belt to a transfer paper in a lump as disclosed in Japanese Patent No. 2002-212867.

The intermediate transferring system does not require a complicated optical system and is also usable for such firm paper as postcards and cardboard. Further, when an intermediate transferring belt is used, as the belt is flexible, it is enabled to downsize an apparatus itself when compared with a transferring drum system/a continuous transferring system.

However, in an image forming method and an apparatus using an intermediate transferring belt, toners go through the transferring process for at least more than two times; from a photosensitive drum to an intermediate transferring belt and further, from an intermediate transferring belt to transfer paper. Therefore, the transferring efficiency is lowered. Further, there are such problems that amount of waste toners increases, toner costs increase and it becomes necessary to make the capacity of a waste toner box more larger. Furthermore, if the transferring efficiency was different for each toner, the difference is magnified and accurate colors cannot be reproduced.

In addition, in case of the color development, it is necessary to superpose four color toner images on an intermediate transferring belt, the toner layer becomes thick and it tends to generate a difference between the toner layers and non-toner layers and thin toner layers. For this reason, local defective transferring of images; that is, partially not transfer of images, so called inner void phenomenon tends to generate. Further, in case of characters and line images, edge phenomena are produced, much toners are placed, cohesion of toners is caused by pressurization, and inner voids become more remarkable. Inner voids appear more remarkably especially under the high humidity and high temperature environment.

### SUMMARY OF THE INVENTION

An object of this invention is to provide an image forming method preventing generation of a defective image reproduction resulting from inner void and toner scatter caused when images are transferred in an image forming method using an intermediate transfer system.

Another object of this invention is to provide a combination of plural kinds of developers to enable it prevent a defective image reproduction caused by inner voids and toner scattering and to obtain a high transferring efficiency when applied to an image forming method using an intermediate transfer system.

According to this invention, there is provided a color image forming method comprising: preparing plural kinds of developers in different colors including toners containing binder resin and coloring agents and carrier; forming a primary transferring image comprising plural developer images in different colors on an intermediate transferring medium by repeating the process to develop electrostatic latent images corresponding to developer colors on an image carrier and then, transfer the developer images on the image carrier to the intermediate transferring medium; and forming a secondary transferring image by transferring the primary transferring image on an image receiving medium, wherein the plural kinds of developers have absolute values of tribo-charge amount 10 to 30 μG/g, an absolute value of tribo-charge amount of a developer lastly used for the development from the plural kinds of developers is larger than an absolute value of tribo-charge amount of a developer first used for the development, and a different between them is more than 2 μC/g×(the number of developers used −1).

Further, according to this invention, there is provided a combination of plural kinds of developers in different colors that are used in a color image forming method comprising a process to form a primary transfer image composed of plural kinds of developers in different colors on an intermediate transferring medium by repeating the developing/transferring process to form electrostatic latent images in colors corresponding to developer colors, form developer images in colors corresponding to the electrostatic latent images, transfer the developer images on an intermediate transferring belt, and a process to form a secondary transferring image by transferring the primary transferring image on an image receiving medium, wherein plural kinds of developers contain toners including binder resins and coloring agents and absolute values of tribo-charge amount of respective developers are 10 to 30 μG/g, and an absolute value of tribo-charge amount of a developer lastly used for the development from the plural kinds of developers is larger than an absolute value of tribo-charge amount of a developer first used for the development, and a different between them is more than 2 μC/g×(the number of developers used −1).

### BRIEF DESCRIPTION OF THE DRAWING

FIG. 1 is a diagram showing one example of an image forming apparatus that is used for the image forming method of this invention.

### DETAILED DESCRIPTION OF THE INVENTION

The principle and a preferred embodiment of this invention will be explained below.

According to the color image forming method of this invention, after a primary transfer image is formed by superposing developer images in different colors on an intermediate transfer member, a secondary transfer image is formed by transferring the primary transfer image at one time on a transfer material, for example, a transfer paper, etc. For example, when four kinds of yellow, magenta, cyan and black toners are used, these color toners are transferred sequentially from an image carrier on an intermediate transfer member maximum 4 times. In the first, second, third and fourth developing/transferring process, the number of charges applied to toners transferred sequentially on the intermediate transfer member differ for 4 times, 3 times, 2 times and 1 time, respectively. Therefore, a transfer image formed in the first developing/transferring process is most liable to be charged up. However, there is such a problem that transfer images formed in the first developing/transferring process are at the position most far from the transfer material in the following second transfer image forming process and therefore, hard to be transferred.

So, in this invention, absolute values of tribo-charge amounts of respective developers are made at 10 to 30 μC/g and an absolute value of a tribo-charge amount of developer supplied for the last development is set larger than that of a developer supplied for the first development with a difference of them set at more than 2 μC/g×(the number of using developers −1). Thus, the tribo-charge amounts of four colors become all the same level even when an absolute value of change amount of a developer transferred on the intermediate transfer member is lower than other developers in the first developing/transferring process. As a result, in the secondary transferring, a developer first developed and transferred near the intermediate transfer member is transferred without being charged up and a satisfactory transfer characteristic is obtained. Furthermore, inner void and scattering of developers in the transfer process are prevented.

In this invention, a developer that is first used in the developing/transferring process is desirable in average particle size larger than those of other developers. Thus, it becomes possible to reduce the number of first developer used per unit area and to make the charging amount of the first developer lower than the charging amounts of other developers. As a result, the mobility in the transfer is improved, the reverse transfer to an image carrier (a photosensitive drum) is prevented and a good transfer characteristic can be obtained. Then, such phenomena as inner void and toner scattering caused when transferring images are also prevented.

Further, the fourth developer that is lastly used in the developing/transferring process is preferred to contain no metallic soap. When metallic soap is contained in the developers in the first to third development/transferring processes, the metal soap is effective as a lubricant for a long life and prevention of film scraping. However, when it is contained in a developer used in the fourth developing and transferring process, it has such disadvantages as decrease of developer transfer efficiency, less amount of developer adhered to a transferring material, production of thin portions on images, etc. On the other hand, a metal soap is not added to the fourth developer that is lastly used in the developing/transferring process to form a transferring image layer that comes on the top of the intermediate transfer member and such disadvantages can be avoided in this invention.

It is desirable that plural kinds of developers are so set that absolute values of their charging amounts differ by more than 2 μC/g in order of use in the developing/transferring process. In this case, plural kinds of developers are preferred that absolute values of their charging amounts are set at levels larger than 2 μC/g in order of use in the developing/transferring process.

Further, it is desirable that a bulk density of a developer that is first used in the developing/transferring process is larger than, for example, 0.01 to 0.03 as it becomes possible to improve the developing characteristic. Further, the bulk density was measured based on a method according to JIS K5101 (Pigment Test Method).

Further, plural kinds of developers are preferable in average particle size of 4 to 9 μm, respectively. Further, a developer that is first used in the developing/transferring process is in average particle size larger than 0.1 μm and smaller than 3.0 μm from average particle sizes of other developers. More preferably, it has average particle size larger by 0.5 μm and smaller by 3.0 μm than average particle sizes of other developers.

Hereinafter, ingredients of developer toners involved in this invention will be explained.

For toners that are used in this invention, polyester resin can be used suitably as a bonding resin. In particular, polyester resin that is obtained through the polycondensation of polyhydric carboxylic acid or its lower alkylester with polyhydric alcohol is desirable.

In order to improve off-set proof and fixing strength, a vegetable wax may be contained in toners. In this invention, a vegetable wax having a melting point 66 to 86° C. according to the DSC is preferable. This wax acts as a fixing improving agent, improves the fixing strength and has an effect to improve the offset durability. A preferred adding amount of vegetable wax is 1 to 20 weight portion per 100 weight portion of bonding resin.

Pigments or dyes that can be used as coloring agents in color toners of this invention are as follows: carbon black, iron black, graphite, nigrosine, metal complex of azo dye, anthraquinone dye, copper phthalocyanine blue, Dupon oil red, aniline blue, benzine yellow, hansa yellow, rose bengal, Rhodamin lake, Alizarin lake, C.I. pigment Red 22, 31, 48-1, 48-3, 53-1, 57-1, 69, 150, C.I. pigment yellow 12, 13, 14, 17, 81, 97. 154. 155. 174. 180, C.I.pigment blue 15, 15-3, 15-4, 15-6, 60 and admixture of above pigments or dyes.

A preferable content of coloring agents is 2 to 15 weight %. When a content of coloring agent is less than 2 weight %, a coloring power becomes weak and when more than 15 weight %, developing sleeve, etc. are polluted by coloring agents.

Further, pigments/dyes for coloring agents are decided in favor of color reproducibility and therefore, adding amount differs depending on pigment/dye and an effect given to electrostatic charge property of developer also Differs, accordingly. However, the effect can be reduced to the minimum by controlling the electrostatic charge property described above.

Further, for the purpose of controlling electrostatic charge property of color toner, a charge control agent may be used. There are two types of charge control agents; for positive charge control and negative charge control. These charge control agents can be used independently or in mix.

Color toners of this invention may contain at least hydrophobic processed silica as an external adding agent.

Further, in the toner used in the first development, metal soap is contained as external adding agent. Such fatty acids as stearic acid, zinc atearate or fine particles of metal salt of these fatty acids are usable as metal soap.

In addition, fine particles of metallic acids such as alumina, titania, magnesia, zirconia, ferrite, magnetite and these fine particles surface treated or coated by such processing agents as silane coupling agent, titanate coupling agent, zirco alminate, quaternary ammonium salt, fatty acids, fatty acid metal salt, fluoric activator, solvent, polymer, etc. or such fatty acids as stearic acid, zinc stearate or particles of metal salt of these fatty acids and these fine paritlces surface treated by the processing agents described above or polymer fine particles of polystylene, polymethacrylic acid methyl, polyfluoride vinilidene, etc. and fine particles of these items surface treated or coated by the processing agnets described above.

Mean particle sizes of these external additives in the range 0.01 to 3μ are used. Further, adding amount of these external additives in the range of 0.1 to 7.0 weight portion per toner particle 100 weight portion, in particular in the range of 0.2 to 5.0 weight portions are preferred.

Toners involved in this invention described above are manufactured basically in pre-mixed, solved and knead, pulverized, sorted and external adding processed state.

As carriers that are used in mix with toners in this invention, silicon treated ferrite particles are preferable.

More preferred, for carrier particles, ferrite in particle size about 80 to 40 μm with core particles expressed by (MO)X(Fe₂O₃)Y(X/Y<1.0, M is one or two kinds of metals selected from a group comprising Li, Mg, Mn, Fe(II), Co, Ni, Cu, Zn, Cd, Sr and Ba) covered by silicon resin with a resistance value of 250V/6.5 mm 1×1⁺¹⁰ to 3×10⁺¹¹ is used.

An image forming apparatus that is used in this invention will be explained below referring to the attached drawing.

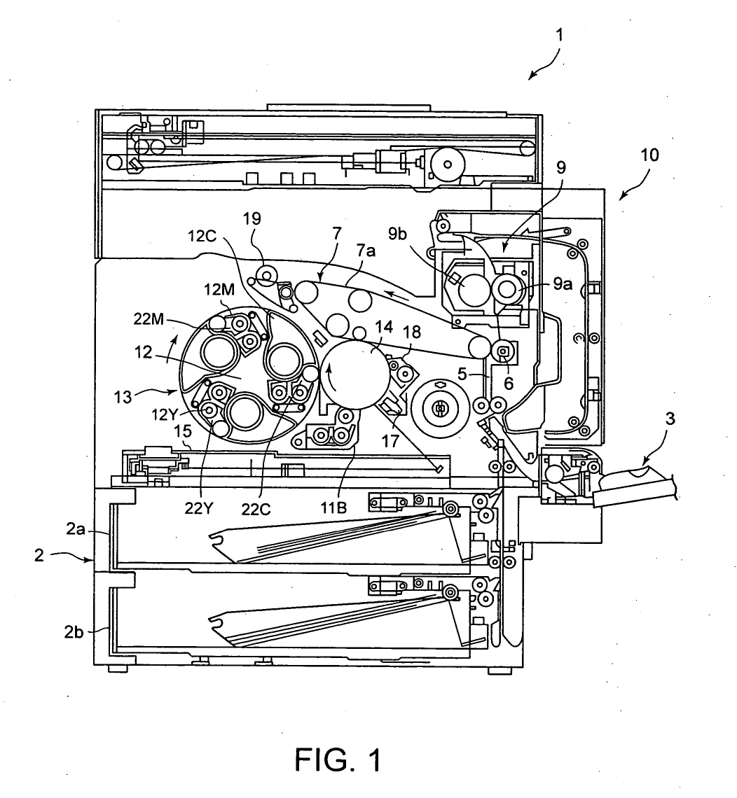

FIG. 1 is a schematic diagram showing one example of an image forming apparatus that is used in the image forming method of this invention.

In FIG. 1, a color image forming apparatus 1 has a paper supply unit 2 provided with 2 stages of a paper supply cassette 2a and 2b and a separately provided manual paper supply cassette 3. A recording paper supplied from paper supply unit 2 or manual paper supply unit 3 is conveyed upward on a vertical conveying path 5 to a secondary transferring roller 6. When the recording paper passes between secondary transferring roller 6 and a belt 7a of an intermediate transferring belt mechanism 7, toner images in various colors are transferred from belt 7a. The recording paper with toner images transferred are heated and pressed when passing between a pressing roller 9a and a heating roller 9b of a fixing device 9 and the toner images are fixed. Reference numeral 10 in FIG. 1 is a duplex unit.

Around a photosensitive drum 14, there are arranged a main charger 17, a developing device 12 and a black developing unit 11B housing four color developers of yellow (Y), magenta (M), cyan (C) and a black (B), intermediate transferring belt mechanism 7 and a drum cleaner 18. Developing units 12 and 11B have a B developing unit 11B and a rotary type developer that is provided separately from B developing unit 11B and has Y, M and C developing units 12Y, 12M and 12C incorporated in a revolver 12. Y, M and C developing units 12Y, 12M, 12C and B developing unit 11B have developing sleeves 22Y, 22M and 22C to supply respective toners to the photosensitive drum and blades (not shown) provided on the surfaces of developing sleeves 22Y, 22M and 22C, respectively at a specified angle (not shown) to control the thickness of Respective developer layers formed on the surfaces of the developing sleeves.

Each developing unit develops, visualizes an electrostatic latent image formed on the surface of photosensitive drum 14 using respective color toners and forms a full-colored toner image by an exposure unit 15. A full-color toner image thus obtained is transferred on belt 7a and further on a recording paper at a position between this belt 7a and secondary transferring roller 6.

The operation of the image forming apparatus described above will be explained below taking an example wherein the developing operation is carried out in order of B, C, M and Y colors. However, the developing sequence is not restricted to this order. That is, the sequence of the developing operation is determined depending on size of absolute value of tribo-charge amount of developer, average particle size of developer, presence of metal soap, size of bulk density, etc. The operating sequence of developing units are arranged in advance according to characteristics of developers as described above or an image forming apparatus is able to operate by changing the sequence of the developing operation automatically according to characteristics of developers by detecting with a sensor, etc.

Further, in the above example, the Y, M and C developing units are incorporated in the revolver and the B developing unit is provided separately. However, it is possible to take a construction with all of Y, M and C developing units incorporated in the revolver or a construction wherein Y, M, C and B developing units are all arranged on the surface of a photosensitive drum opposing to each other or lined up in a row, and the arrangement is not restricted to the example described above.

When the copy operation is started, the reading of B image data starts at a specified timing with a color scanner (not shown) and based on this image data, the latent image formation on photosensitive drum 14 by laser beam starts. At this time, a magnetic brush formed on a developing roller of B developing unit 11B is moved close to the surface of photosensitive drum 14 and the development is carried out. At this time, specified DC bias and/or AC bias is applied from a bias applying device (not shown) to B developing unit 11B. At the same time of the image formation, specified DC bias and/or AC bias is applied to a transferring bias roller from the bias applying device (not shown) and a black toner image is transferred to intermediate transferring belt 7. Immediately after all black toner images are transferred, B developing unit 11B is separated from photosensitive drum 14 and after C developing unit 12C of the color image forming unit arrives at an image forming position, a cyan toner image is formed and transferred by a cyan signal likewise before. Until this time, intermediate transferring belt 7a is rotated by one turn and a cyan signal write-in timing is controlled so that next cyan tone image agrees to a position of a black toner image that was transferred previously. While intermediate transferring belt 7a is separated from photosensitive drum 14 and does not disturb the toner image formed on intermediate transferring belt 71.

The same operations as described above are carried out for magenta and yellow toner images and toner images in 4 colors are superposed each other at the matched position and four color images are formed on intermediate transferring belt 7a. After a last yellow toner image is transferred, four color images are transferred in a lump on a paper sent from a paper supply cassette (not shown) timely through a paper conveying roller by the action of secondary transferring roller. The toner images transferred on a paper is fixed by a pair of fixing roller pair 9a and 9b. The paper is then discharged to the outside of the apparatus. Residual toners remained on intermediate transferring belt 7a are subject to charge elimination and then, cleaned by a transferring belt cleaning unit (not shown) and prepared for next image forming.

[Embodiment]

A preferred embodiment of this invention will be shown below and the effect of this invention will be definitely explained.

According to a preferred embodiment, this invention will be explained below more in detail. Amounts (portions) of ingredients shown in the embodiment and comparison examples are weight portions.

Black toner, yellow toner, magenta toner and cyan toner are prepared in the toner composition shown below.

Toner Set A

Black Toner Composition:

| | |
|---|---|
| Binder resin (polyester resin acid value: 20, | 100 portions |
| softening point: 119° C., Weight-average molecular | |
| weight: 31000, Number-average molecular weight: | |
| 2800) | |
| Coloring agent (carbon black) | 7 portions |
| Wax 1 (Carnauba wax Melting Point: 83° C.) | 2 portions |
| Wax 2 (PP wax Melting Point: 145° C.) | 5 portions |
| CCA (Zr metal complex) | 1 portion |

Color toner composition:

| | |
|---|---|
| Binder resin (polyester resin Acid value: 10, | 100 portions |
| Softening Point 120° C., Weight-average molecular | |
| weight: 45000, Number-average molecular weight: 3000) | |
| Coloring agents (pigments for YMC colors) | 8 portions |
| Wax 1 (Rice wax Melting Point: 79° C.) | 2 portions |
| Wax 2 (PP wax Melting Point 145° C.) | 5 portions |
| CCA (Zr metal complex) | 1 portion |

After mixing using a Henschel mixer, above materials were molten and kneaded with a two-axle extrusion machine. The molten and kneaded materials thus obtained were cooled and then, coarsely crushed with a hammer mill and then, a jet crushing machine, classified and fine particles of black toner in volume average particle size 8.5 μm and fine particle of color toners in volume average particle size 8 μm were obtained. Hydrophobic silica 2.5 portions and hydrophobic titanium oxide 0.5 portions and further, excepting yellow toner, zinc stearate 0.25 portions were added and mixed with 100 portions of this fine particles and toners were produced.

Average particle size and dimensional gravity of toners are as shown on Table 1 below.

For carrier particles, coating liquids are prepared according to the prescriptions shown below as carrier coating materials.

| | |
|---|---|
| First Layer | |
| Silane coupling agent | 100 portions |
| Second Layer | |
| Silicon resin liquid (Toray Silicon SR2406, Solid | 500 portions |
| Content 20%) | |
| Conductive ketchen black EC (LionAkzo Co., Ltd.) | 4.0 portions |
| Toluen | 1500 portions |

10 kg of ferrite carrier in average particle size 40 μm were put into a rotating disc fluidized bed particle coater and the first layer recipe coating liquid was coated by spraying together with nitrogen gas at a normal temperature while fluidizing the carrier. Then, the second layer recipe coating liquid was dispersed at 80° C. Then, the coated carrier was take out of the coater, put in a thermostat chamber, heated for 2 hours at 200° C. and a silicon film was hardened. This carrier was made as Carrier A.

By adding Carrier A to 8 portions of each color toner to a total amount 100 portions and a two-component developer was produced.

All developers have the same amount of CCA (Charge Control Agent) but tribo-charge amount of respective developers are as shown in Table 1 according to selected particle sizes and pigments.

Using toners and developers shown in Table 1, the image forming was conducted by changing a combination of developing sequences as shown in Table 2 with the image forming apparatus shown in FIG. 1 and the obtained images were evaluated. That is, the transfer property (inner void, dissipation of characters) in the character portion when 4 colors were superposed was evaluated; image density of a solid image portion, resolution of a line image portion, and transferring efficiency were evaluated. The results of the evaluations are shown in Table 3.

Further, the evaluation was conducted according to the following criteria:

Transfer Inner Void

◯: visually not recognizable but less than 5 can be recognized with a loupe
Δ: visually not recognizable but more than 5 points can be recognized with a loupe
X: Inner void is visually recognizable
   Transfer Character Dissipation
◯: Visually not recognizable but slightly recognizable with a loupe.
Δ: Visually not recognizable but several points are recognizable with a loupe
X: Toner scattering can be visually recognized
   Image Density
Densities of respective colors were measure with a GretagMacbeth reflecting densitometer (Macbeth Co., Ltd.)
◯: Bk 1.3 or more, YMC 1/1 or more).
Δ: Bk 1.3 to 1.1, YMC 1.1 to 1.0
X: Bk 1.1 or below, YMC 1.0 or below
   Resolution
Line images of 16 lines/mm were measured with a micro-densitometer (Konica Corp.).
◯: More than 70%
Δ: 50 to 70%
X: Completely crushed and not resolved. Resolution is below 50%

Further, “Resolved” denotes that, for example, lines of 16 lines/mm are separated.

Transferring Rate

Transferring efficiency of a toner developed on a photosensitive drum until it is transferred on a paper via an intermediate transferring belt was obtained.
◯: More than 90%
Δ: 80 to 90%

X: below 80%

TABLE 1

| | Average | | | |
|---|---|---|---|---|
| | Particle | Bulk | Tribo-Charge | Presence of |
| | Size | Density | Amount | Metal Soap |
| Toner | (μm) | (g/cm 3) | (μC/g) | Yes/No |
| Bk1 | 8.0 | 0.36 | −15 | Yes |
| Bk2 | 9.5 | 0.37 | −8 | Yes |
| Bk3 | 7.0 | 0.33 | −30 | No |
| C1 | 7.0 | 0.33 | −20 | Yes |
| C2 | 6.0 | 0.32 | −40 | Yes |
| C3 | 5.0 | 0.31 | −26 | Yes |
| M1 | 7.0 | 0.33 | −24 | Yes |
| M2 | 8.0 | 0.32 | −33 | Yes |
| M3 | 5.0 | 0.31 | −24 | Yes |
| Y1 | 7.0 | 0.33 | −27 | No |
| Y2 | 8.0 | 0.32 | −35 | Yes |
| Y3 | 8.0 | 0.36 | −20 | Yes |

TABLE 2

| | 1st | 2nd | 3rd | 4th |
|---|---|---|---|---|
| | Development | Development | Development | Development |
| Embodiment 1 | Bk1 | C1 | M1 | Y1 |
| Embodiment 2 | Y3 | M3 | C3 | Bk3 |
| Comparison | Bk1 | C1 | M1 | Y2 |
| Example 1 | | | | |
| Comparison | Bk2 | Y2 | M2 | C2 |
| Example 2 | | | | |
| Comparison | Y2 | M2 | C2 | Bk2 |
| Example 3 | | | | |

TABLE 3

| | Transfer | Transfer | | | | |
|---|---|---|---|---|---|---|
| | Inner | Character | Image | | Transferring | |
| | Void | Dissipation | Density | Resolution | Rate | Judgement |
| Embodiment 1 | ◯ | ◯ | ◯ | ◯ | ◯ | ◯ |
| Embodiment 2 | Δ | ◯ | Δ | ◯ | ◯ | ◯ |
| Comparison | X | X | Δ | X | Δ | X |
| Example 1 | | | | | | |
| Comparison | Δ | Δ | Δ | Δ | Δ | Δ |
| Example 2 | | | | | | |
| Comparison | X | X | X | X | X | X |
| Example 3 | | | | | | |

From the above Table 3, it is seen that absolute values of 4 kinds of developers are 10 to 30 μC/g and absolute values of tribo-charge amounts of the developers used in the first development is larger than the absolute value of tribo-charge amount of developer used in the fourth development and the difference is more than 2 μC/g×(4−1); that is, more than 6 μC/g, and in the embodiments 1 and 2, good evaluation results were obtained in Embodiments 1 and 2.

On the contrary, in Comparison Example 1 using developers of which absolute value of tribo-charge amount is more than 30 μC/g (that is, 35 μC/g), inner void, dissipation of transferred character and poor resolution were recognized and the evaluation was “X”. Further, in the comparison example 2 using developers of absolute value of tribo-charge amount is (8 μC/g) that is lower than 10 μC/g, there was no good evaluation item and the judgment was “Δ”. Further, in the comparison example 2 wherein absolute values of tribo-charge amount of all developers were outside the range of 10 to 30 μC/g and the absolute values of tribo-charge amount of developers used in the fourth development were far smaller than the absolute values of developers used in the first development, all evaluation items were low and the judgement was “X”.

As explained above in detail, according to this invention, in a color image forming method to form a primary transferring image by repetitively develop using plural kind developers in different colors and transfer on an intermediate transfer medium and then, form a secondary transferring image by transferring the primary transferring image on a transfer material, absolute values of tribo-charge amount of plural kinds of developers were 10 to 30 μC/g. Further, a developer such that of which absolute value of tribo-charge amount of a developer lastly used for the development is larger than a developer first used and a difference between them is more than 2 μC/g×(the number of developers used −1) is used. Thus, an extremely excellent effect is displayed so as to obtain a very good transferring characteristic.

1. A color image forming method comprising:
preparing plural kinds of developers in different colors including toners containing binder resin and coloring agents and carrier;
forming a primary transferring image comprising plural developer images in different colors on an intermediate transferring medium by repeating the process to develop electrostatic latent images corresponding to developer colors on an image carrier and then, transfer the developer images on the image carrier to the intermediate transferring medium; and
forming a secondary transferring image by transferring the primary transferring image on an image receiving medium, wherein the plural kinds of developers have absolute values of tribo-charge amount 10 to 30 μG/g,
an absolute value of tribo-charge amount of a developer lastly used for the development from the plural kinds of developers is larger than an absolute value of tribo-charge amount of a developer first used for the development, and a different between them is more than 2 μC/g×(the number of developers used −1).

2. The color image forming method according to claim 1, wherein the developer first used for the development/transferring process is larger in average particle size than other developers.

3. The color image forming method according to claim 1, wherein excepting the developer lastly used for the development/transferring process, remaining developers contain metal soap.

4. The color image forming method according to claim 1, wherein the plural kinds of developers are so set that the absolute values of tribo-charge amounts become different each other by more than 2 μC/g in the sequence of use for the development/transferring process.

5. The color image forming method according to claim 4, wherein the plural kinds of developers are so set that the absolute values of tribo-charge amounts becomes larger than 2 μC/g, respectively in the sequence of use for the development/transferring process.

6. The color image forming method according to claim 1, wherein the developer that is first used for the development/transferring process has a dimensional specific gravity larger than those of other developers.

7. The color image forming method according to claim 1, wherein the plural kinds of developers have average 4 to 9 μm particle sizes.

8. The color image forming method according to claim 1, wherein the developer that is first used for the development/transferring process has average particle sizes larger than average particle sizes of other developers by more than 0.1 μm and smaller than 3.0 μm.

9. A combination of plural kinds of developers in different colors that are used in a color image forming method comprising a process to form a primary transfer image composed of plural kinds of developers in different colors on an intermediate transferring medium by repeating the developing/transferring process to form electrostatic latent images in colors corresponding to developer colors, form developer images in colors corresponding to the electrostatic latent images, transfer the developer images on an intermediate transferring belt, and a process to form a secondary transferring image by transferring the primary transferring image on an image receiving medium,
wherein plural kinds of developers contain toners including binder resins and coloring agents and absolute values of tribo-charge amount of respective developers are 10 to 30 μG/g, and
an absolute value of tribo-charge amount of a developer lastly used for the development from the plural kinds of developers is larger than an absolute value of tribo-charge amount of a developer first used for the development, and a different between them is more than 2 μC/g×(the number of developers used −1).

10. The combination of plural kinds of developers according to claim 9, wherein the average particle size of the developer that is first used for the development/transferring process is larger than other developers.

11. The combination of plural kinds of developers according to claim 9, wherein excepting the developer that is used lastly for the development/transferring process, the remaining developers contain metal soap.

12. The combination of plural kinds of developers according to claim 9, wherein the plural kinds of developers are so set that an absolute value of tribo-charge amount differs each other by more than 2 μC/g.

13. The combination of plural kinds of developers according to claim 12, wherein the plural kinds of developers are so set that their absolute values of tribo-charge amounts become larger than 2 μC/g, respectively in order of using in the development/transferring process.

14. The combination of plural kinds of developers according to claim 9, wherein a developer that is first used for the development/transferring process has a larger specific gravity than other developers.

15. The combination of plural kinds of developers according to claim 8, wherein the plural kinds of developers have average particle sizes of 4 to 9μ, respectively.

16. The combination of plural kinds of developers according to claim 8, wherein a developer that is first used for the development/transferring process have average particle sizes larger than other developers by 0.1 μm and smaller by 3.0 μm.
